(19) United States
(12) Patent Application Publication
(10) Pub. No.: US 2023/0189240 A1
(43) Pub. Date: Jun. 15, 2023

(54) MULTIPLE TRP SIDELINK TTP INDICATION TO ENABLE AGC PREDICTION

(71) Applicant: QUALCOMM Incorporated, San Diego, CA (US)

(72) Inventors: Kapil Gulati, Belle Mead, NJ (US); Junyi Li, Fairless Hills, PA (US); Shuanshuan Wu, San Diego, CA (US); Sourjya Dutta, San Diego, CA (US); Hui Guo, Beijing (CN)

(21) Appl. No.: 18/000,344

(22) PCT Filed: May 29, 2021
(86) PCT No.: PCT/CN2021/097031

§ 371 Date: Nov. 30, 2022

(30) Foreign Application Priority Data
May 30, 2020 (WO) PCT/CN2020/093603

(51) Int. Cl. H04W 72/044; H04W 72/25; H04W 52/52

(52) U.S. Cl. CPC H04W 72/0473; H04W 72/25; H04W 52/52

(57) ABSTRACT

In one aspect, a method of wireless communication includes transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power QCL indication for at least one transmission of the one or more second transmissions. The method further includes transmitting, by the wireless communication device, a particular transmission of the one or more second transmissions using a particular set of transmission resources of the second set of one or more of transmission resources based on the total transmit power QCL indication. In another aspect, a transmit power configuration indication may be sent in place of the total transmit power QCL indication, as a generalization and extension of the TTP QCL indication. Other aspects and features are also claimed and described.

### TECHNICAL FIELD

Aspects of the present disclosure relate generally to wireless communication systems, and more particularly, to multiple transmission reception point (TRP) communications. Certain embodiments of the technology discussed below can enable and provide total transmit power (TTP) indication and/or quasi co-location (QCL) indication for automatic gain control determination for sidelink channel communications.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EMBODIMENTS

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a transmit power configuration indication for at least one transmission of the one or more second transmissions; and transmitting, by the wireless communication device, a particular transmission of the one or more second transmissions using a particular set of transmission resources of the second set of one or more of transmission resources based on the transmit power configuration indication.

In an additional aspect of the disclosure, an apparatus configured for wireless communication is disclosed. The apparatus includes at least one processor, and a memory coupled to the processor. The processor is configured to transmit a transmission using a first set of transmission resources, wherein the transmission includes an indication of a second set of one or more of transmission resources in the future that the apparatus intends to use for one or more second transmissions, and wherein the transmission includes a transmit power configuration indication for at least one transmission of the one or more second transmissions; and transmit a particular transmission of the one or more second transmissions using a particular set of transmission resources of the second set of one or more of transmission resources based on the transmit power configuration indication.

In another aspect of the disclosure, a method of wireless communication includes receiving, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a transmit power configuration indication for at least one transmission resource set of the second set of one or more of transmission resources; determining, by the wireless communication device, a total transmit power for a particular set of transmission resources of the second set of one or more of transmission resources based on the transmit power configuration indication; determining, by the wireless communication device, a receiver gain value to apply for receptions during the particular set of transmission resources based on the total transmit power for a particular set of transmission resources; and monitoring, by the wireless communication device, for a particular transmission of the one or more second transmissions during the particular set of transmission resources using the receive gain value.

In an additional aspect of the disclosure, an apparatus configured for wireless communication is disclosed. The apparatus includes at least one processor, and a memory coupled to the processor. The processor is configured to receive, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a transmit power configuration indication for at least one transmission resource set of the second set of one or more of transmission resources; determine, by the wireless communication device, a total transmit power for a particular set of transmission resources of the second set of one or more of transmission resources based on the transmit power configuration indication; determine, by the wireless communication device, a receiver gain value to apply for receptions during the particular set of transmission resources based on the total transmit power for a particular set of transmission resources; and monitor, by the wireless communication device, for a particular transmission of the one or more second transmissions during the particular set of transmission resources using the receive gain value.

In another aspect of the disclosure, a method of wireless communication includes transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power QCL indication for at least one transmission of the one or more second transmissions; and transmitting, by the wireless communication device, a particular transmission of the one or more second transmissions using a particular set of transmission resources of the second set of one or more of transmission resources based on the total transmit power QCL indication.

In an additional aspect of the disclosure, an apparatus configured for wireless communication is disclosed. The apparatus includes means for transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power QCL indication for at least one transmission of the one or more second transmissions; and means for transmitting, by the wireless communication device, a particular transmission of the one or more second transmissions using a particular set of transmission resources of the second set of one or more of transmission resources based on the total transmit power QCL indication.

In an additional aspect of the disclosure, a non-transitory computer-readable medium having program code recorded thereon. The program code further includes code to transmit, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power QCL indication for at least one transmission of the one or more second transmissions; and transmit, by the wireless communication device, a particular transmission of the one or more second transmissions using a particular set of transmission resources of the second set of one or more of transmission resources based on the total transmit power QCL indication.

In an additional aspect of the disclosure, an apparatus configured for wireless communication is disclosed. The apparatus includes at least one processor, and a memory coupled to the processor. The processor is configured to transmit, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power QCL indication for at least one transmission of the one or more second transmissions; and transmit, by the wireless communication device, a particular transmission of the one or more second transmissions using a particular set of transmission resources of the second set of one or more of transmission resources based on the total transmit power QCL indication.

In another aspect of the disclosure, a method of wireless communication includes receiving, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a total transmit power QCL indication for at least one transmission resource set of the second set of one or more of transmission resources; determining, by the wireless communication device, a total transmit power for a particular set of transmission resources of the second set of one or more of transmission resources based on the total transmit power QCL indication; determining, by the wireless communication device, a receiver gain value to apply for receptions during the particular set of transmission resources based on the total transmit power for a particular set of transmission resources; and monitoring, by the wireless communication device, for a particular transmission of the one or more second transmissions during the particular set of transmission resources using the receive gain value.

In an additional aspect of the disclosure, an apparatus configured for wireless communication is disclosed. The apparatus includes means for receiving, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a total transmit power QCL indication for at least one transmission resource set of the second set of one or more of transmission resources; means for determining, by the wireless communication device, a total transmit power for a particular set of transmission resources of the second set of one or more of transmission resources based on the total transmit power QCL indication; means for determining, by the wireless communication device, a receiver gain value to apply for receptions during the particular set of transmission resources based on the total transmit power for a particular set of transmission resources; and means for monitoring, by the wireless communication device, for a particular transmission of the one or more second transmissions during the particular set of transmission resources using the receive gain value.

In an additional aspect of the disclosure, a non-transitory computer-readable medium having program code recorded thereon. The program code further includes code to receive, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a total transmit power QCL indication for at least one transmission resource set of the second set of one or more of transmission resources; determine, by the wireless communication device, a total transmit power for a particular set of transmission resources of the second set of one or more of transmission resources based on the total transmit power QCL indication; determine, by the wireless communication device, a receiver gain value to apply for receptions during the particular set of transmission resources based on the total transmit power for a particular set of transmission resources; and monitor, by the wireless communication device, for a particular transmission of the one or more second transmissions during the particular set of transmission resources using the receive gain value.

In an additional aspect of the disclosure, an apparatus configured for wireless communication is disclosed. The apparatus includes at least one processor, and a memory coupled to the processor. The processor is configured to receive, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a total transmit power QCL indication for at least one transmission resource set of the second set of one or more of transmission resources; determine, by the wireless communication device, a total transmit power for a particular set of transmission resources of the second set of one or more of transmission resources based on the total transmit power QCL indication; determine, by the wireless communication device, a receiver gain value to apply for receptions during the particular set of transmission resources based on the total transmit power for a particular set of transmission resources; and monitor, by the wireless communication device, for a particular transmission of the one or more second transmissions during the particular set of transmission resources using the receive gain value.

Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments. In similar fashion, while exemplary embodiments may be discussed below as device, system, or method embodiments the exemplary embodiments can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3A is a diagram of a first example of Automatic Gain Control (AGC) operations.

FIG. 3B is an example diagram illustrating multiple devices of network.

FIG. 3C is an example diagram for AGC prediction for the multiple transmitting devices of FIG. 3B

FIG. 3D is a diagram of an example of multiple transmission reception point (TRP) operations.

FIG. 4 is a block diagram illustrating an example of a wireless communications system with QCL indication for AGC.

FIG. 5 is a diagram of an example of a ladder diagram of QCL indication for AGC for multiple TRP operations according to some embodiments of the present disclosure.

FIGS. 6A-6H are diagrams illustrating example QCL indicators and corresponding transmit powers for multiple TRPs.

FIG. 7 is a flow diagram illustrating example blocks executed by a UE configured according to an aspect of the present disclosure.

FIG. 8 is a flow diagram illustrating example blocks executed by a base station configured according to an aspect of the present disclosure.

FIG. 9 is a block diagram conceptually illustrating a design of a UE configured to perform QCL indication for AGC operations according to some embodiments of the present disclosure.

FIG. 10 is a block diagram conceptually illustrating a design of a base station configured to perform QCL indication for AGC operations according to some embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in communication as between two or more wireless devices in one or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as GSM. 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. An operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to exemplary LTE implementations or in an LTE-centric way, and LTE terminology may be used as illustrative examples in portions of the description below; however, the description is not intended to be limited to LTE applications. Indeed, the present disclosure is concerned with shared access to wireless spectrum between networks using different radio access technologies or radio air interfaces, such as those of 5G NR.

Moreover, it should be understood that, in operation, wireless communication networks adapted according to the concepts herein may operate with any combination of licensed or unlicensed spectrum depending on loading and availability. Accordingly, it will be apparent to one of skill in the art that the systems, apparatus and methods described herein may be applied to other communications systems and applications than the particular examples provided.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

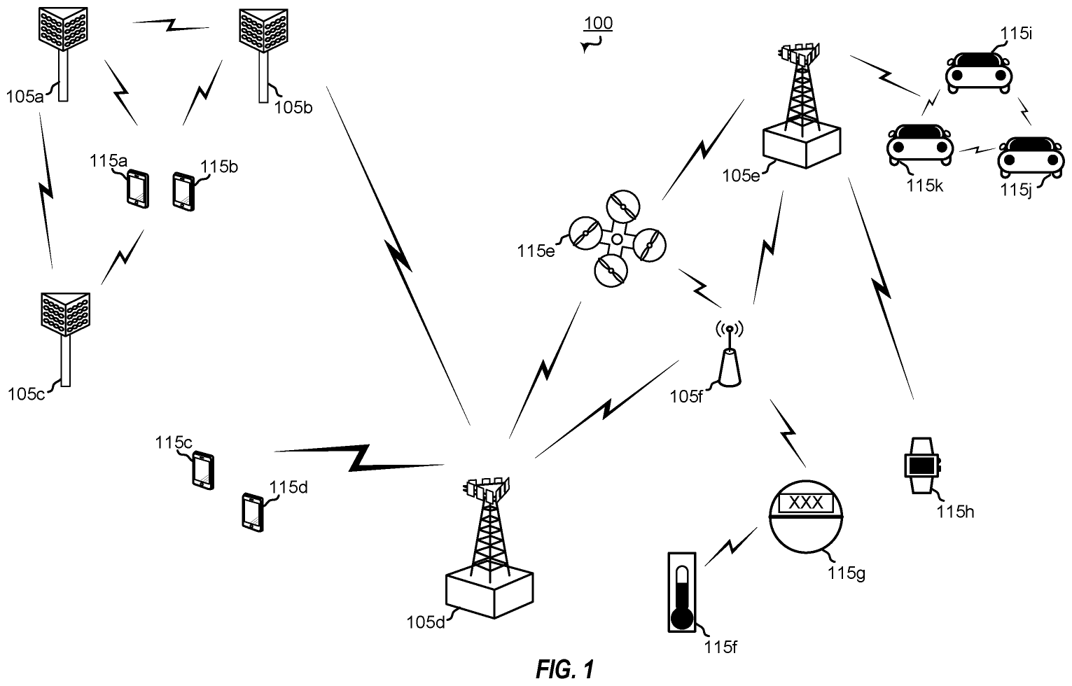

FIG. 1 shows wireless network 100 for communication according to some embodiments. Wireless network 100 may, for example, comprise a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may comprise a plurality of operator wireless networks), and may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3rd Generation Partnership Project (3GPP), such apparatus may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may comprise embodiments of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the embodiment illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a lightning bolt (e.g., communication link) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of embodiments supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

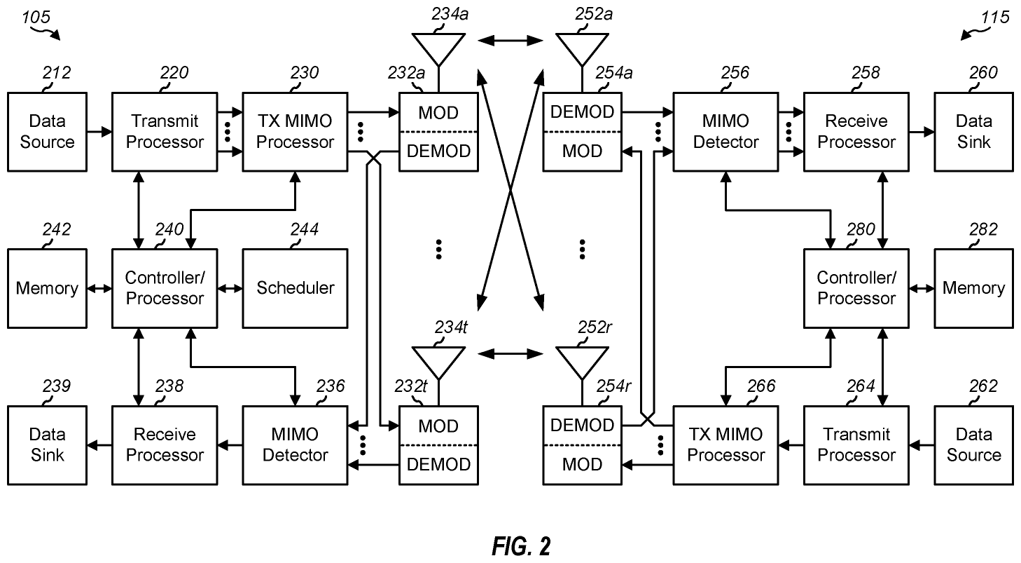

FIG. 2 shows a block diagram of a design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

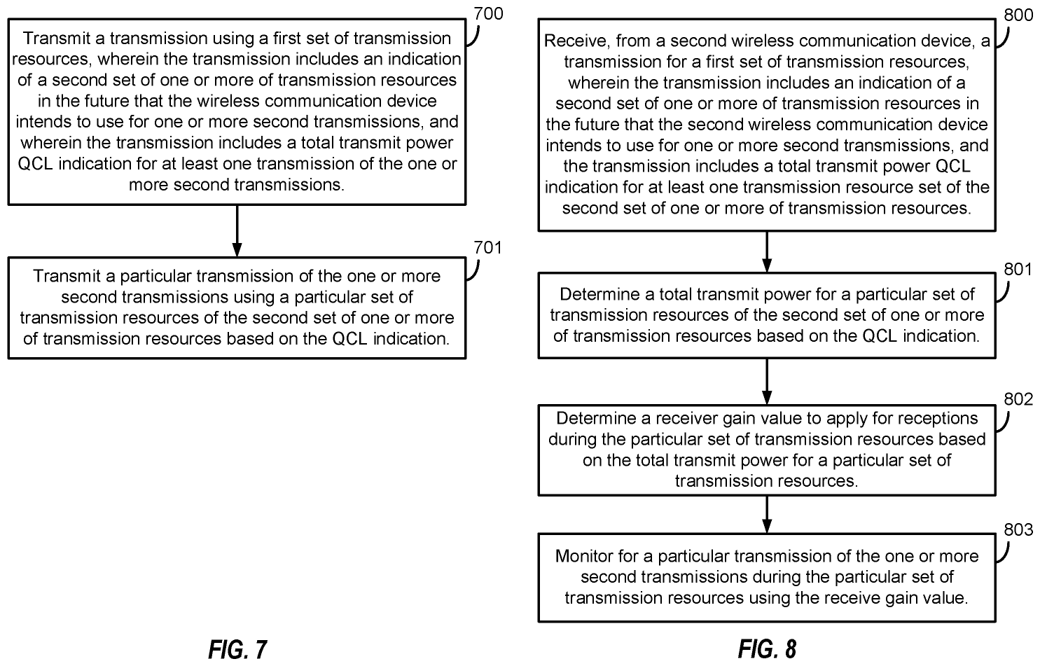

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIGS. 7 and 8, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

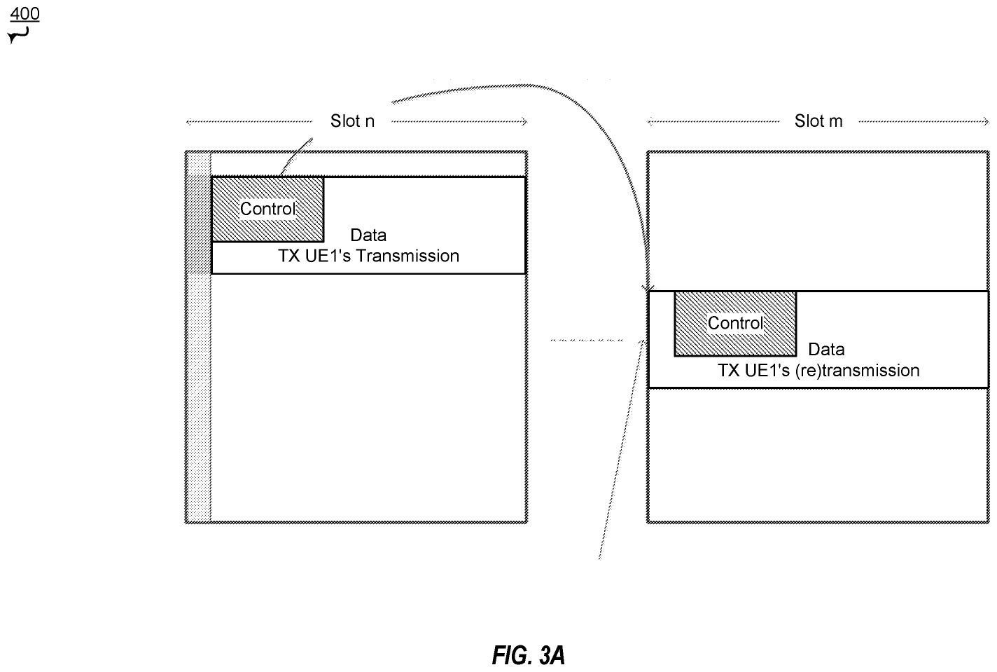

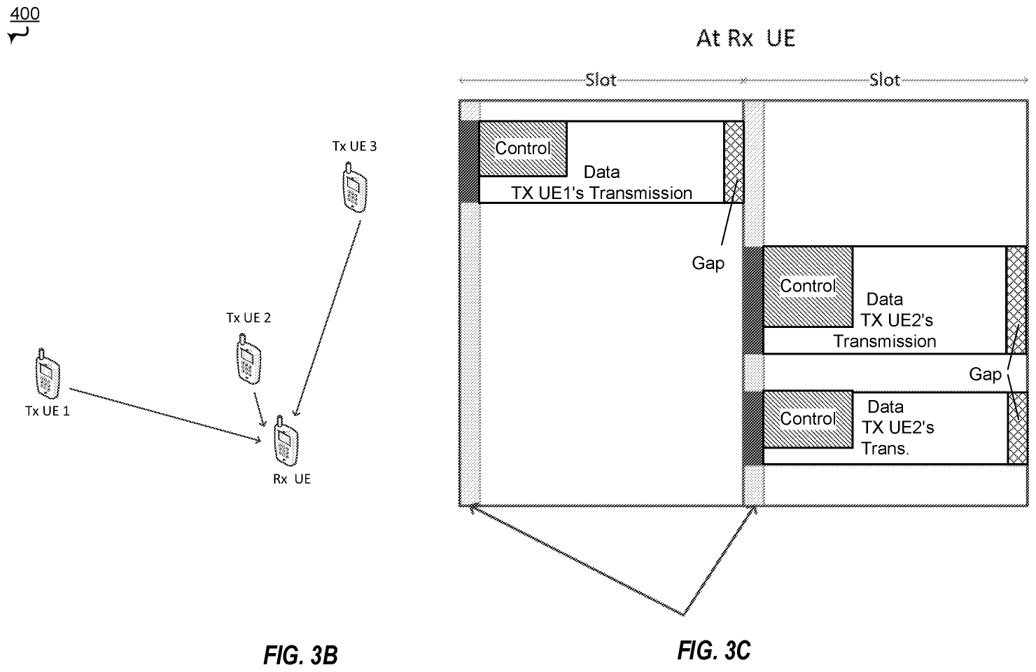

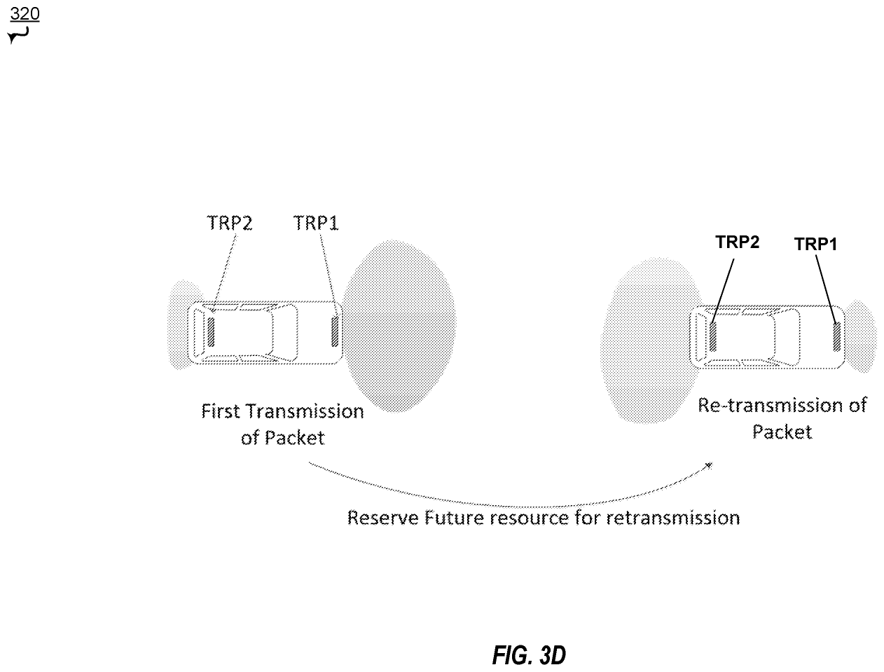

FIGS. 3A-3D illustrate diagrams relevant for automatic gain control (AGC) and multiple transmission reception point (TRP) operations. Referring to FIG. 3A, FIG. 3A illustrates an example diagram 300 for AGC prediction for a single transmitting device with a single antenna port/TRP. Referring to FIG. 3A, the diagram 300 illustrates a transmission timing diagram for two slots. In a first slot (slot n), a transmitting device (TX UE1) transmits a transmission to a receiving device. The transmission includes a control portion and a data portion. In the control portion, an indication is included to indicate a resource reservation for a future slot, such as a second slot (slot m). The receiving device determines (e.g., correlates) the receive power for the second slot based on the receive power of the first slot. To illustrate, the receiving device may use the same gain as it determined for/during the first slot. As no other transmissions are sent during the second slot, and no change in reception power occurred (e.g., as from mobility and/or transmit power of TX device), the AGC determined received gain results in an accurate AGC prediction for the second slot. For such successful/accurate AGC predictions, the receiving device may not have to use or adjust low-noise amplification (LNA) gain or may use or adjust less LNA gain during the second slot. As an illustration, a first portion (e.g., a previous portion that was dedicated to AGC operations during/in slot n that occurred before the control portion) of the second slot, slot n, may be configurable for data transmission and/or operations. Additional devices and/or antenna ports/TRPs complicates such AGC prediction, as do changes in transmit power and/or mobility. The upper, curved line illustrates that the control from slot n indicate a resource reservation in a future slot, such as slot m. The lower, straight line indicates that total received power in slot m (which is after slot n) is correlated with slot n. In the example of FIG. 3, TX UE1 is the only transmitting device, and thus a receiving UE may use the same gain for slot m as determined in slot n.

Referring to FIG. 3B, FIG. 3B illustrates an example diagram 310 illustrating multiple devices of a network. In FIG. 3B, a receiving device receives transmissions from up to three transmitting devices per slot. Also, as the transmitting devices are located in different positions at different distances, the receiving device may receive the transmissions with different receive powers.

Referring to FIG. 3C, FIG. 3C is an example diagram 320 of AGC prediction for multiple transmitting devices with a single antenna, such as the devices of FIG. 3B. Referring to FIG. 3C, the diagram 320 illustrates a transmission timing diagram for two slots. In a first slot (slot n), a first transmitting device (TX UE1) transmits a transmission to a receiving device (RX UE). The transmission includes a control portion and a data portion. In the control portion, an indication is included to indicate a resource reservation for a future slot, such as a second slot (slot m). The receiving device may attempt to determine (e.g., correlate) the receive power for the second slot (slot m) based on the receive power of the first slot (slot n). However, the receiving device also is scheduled for transmissions from additional devices in the second slot. Such additional transmissions may cause AGC operations and a resulting receiver gain value to be inaccurate if the UE does not know the transmit power and/or cannot accurately predict their transmit power. The lower, two lines indicate that an AGC setting may be used at a start of every slot as total received power in a slot may change (e.g., from the previous slot). Whether LNA gain is used for AGC operations may depend on the default gain used at the start of the slot.

To illustrate, the receiving device may need to adjust the previous gain it determined for/during the first slot for the second slot based on the transmit power of one or more of the second and third transmitting devices. As an example, if the receiving device knows the transmit power of the other transmitting devices, it may perform AGC operations for all (three) transmitting devices during the slot. As another example, if the receiving device does not know the transmit power of one or more devices it may not perform any AGC operations. Alternatively, if the receiving device does not know the transmit power of one or more devices it may perform any AGC operations only for the devices it knows the transmit power for. Accordingly, in such instances where the AGC operations are not performed or are inaccurate, the second slot may have a smaller/conventional sized data portion, as illustrated in FIG. 3B, as compared to the data portion of slot m of in FIG. 3A. Additional antenna ports/TRPs per device and the directional nature of 5G communications and other beamforming wireless schemes complicates such AGC prediction.

FIG. 3D illustrates an example diagram of a multiple antenna port/TRP device in operation during two slots. In the example FIG. 3D, the device is a vehicle. As illustrated in FIG. 3D, the vehicle has two antenna ports, a forward (e.g., forward facing/directional antenna) TRP (TRP1) and a rear (e.g., rear facing/directional antenna) TRP (TRP2). For a first transmission, a first TRP (TRP1) has a higher individual transmit power and a second TRP (TRP2) has a lower transmit power. For one or more future transmissions, such as a second transmission, the first TRP (TRP1) has a lower transmit power and the second TRP (TRP2) has a higher transmit power. Even though the total transmit power for each transmission may be the same at the transmitting device, a particular receiving device will receive different amounts of total transmit power based on location. For example, if the receiving device is in front of the vehicle, the receiving device will actually receive less total power for the second transmission, due to the reduced transmit power of the first TRP (TRP1). Thus, if no indication is provided for such multiple TRP operations, the receiving device gain setting will be inaccurate or it will not be able to perform AGC at all, similar as illustrated in FIG. 3B. Accordingly, for conventional networks, AGC prediction operations may only be performed in a limited amount of circumstances and cannot be performed for multiple TRP operations.

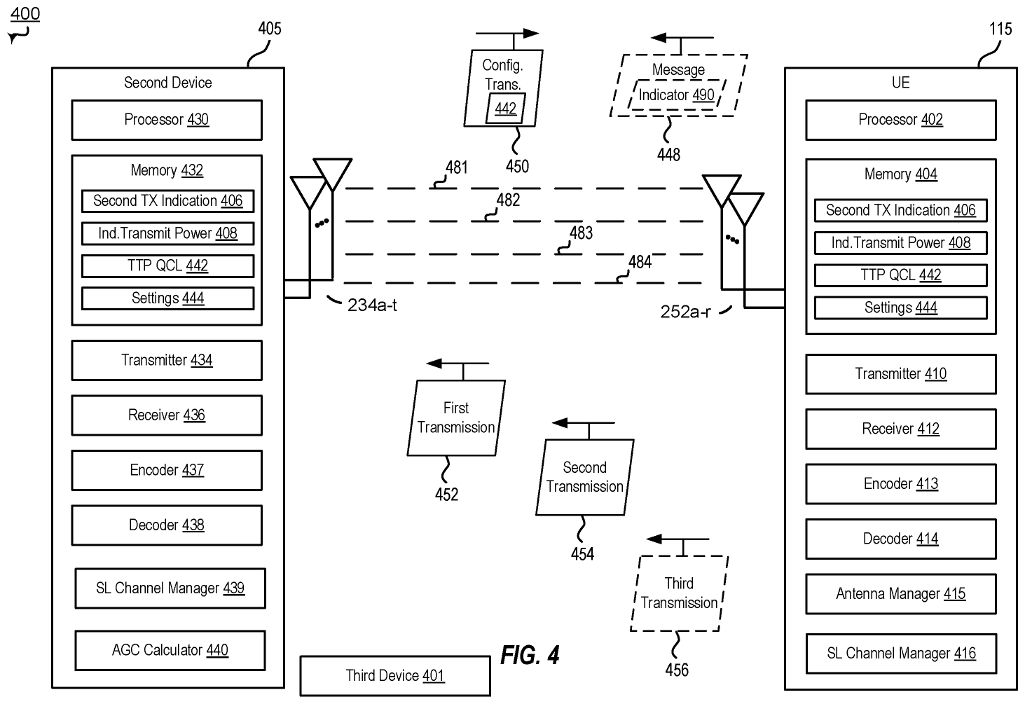

FIG. 4 illustrates an example of a wireless communications system 400 that supports total transmit power (TTP) and/or quasi-co-location (QCL) indication for AGC determination for multiple TRPs in accordance with aspects of the present disclosure. Two signals transmitted from same antenna port generally experience the same radio channel, whereas transmitting two signals from two different antenna ports may results in the two signals experiencing different radio conditions. However, there can be some cases where transmitting signals from two different antenna ports experience radio channels having similar conditions and/or common channel properties. In such cases the antenna ports said to be Quasi-Co-located or QCL. For example, two antenna ports are often referred to as quasi co-located if properties of the channel over which a symbol on one antenna port is conveyed can be inferred from the channel over which a symbol on the other antenna port is conveyed. The channel conditions can include one or more of Doppler Shift, Doppler Spread, average delay, delay spread, a spatial receive parameter, etc. Such conditions may be grouped and when the conditions are the same the type of QCL may be referred to as QCL Type A, B, C, etc.

In some examples, wireless communications system 400 may implement aspects of wireless communication system 100. For example, wireless communications system 400 may include UE 115 and second device 405 (e.g., a network entity, such as a base station, or a second UE). The wireless communications system 400 may optionally include a third device 401 (e.g., a third UE). The TTP and/or QCL indication operations described herein may enable AGC for multiple TRPs (mTRP) and in sidelink channel communications. Thus, AGC and its advantages can be applied to mTRP and/or sidelink channel communications. Accordingly, vehicle-to-vehicle (V2V) and vehicle-to-everything (V2X) type communications may now be able to perform AGC operations and/or have increased accuracy AGC predictions. Therefore, throughput and reliability are increased when operating with mTRP and/or sidelink channel communications, and thus, network and device performance can be increased.

Second device 405 and UE 115 UE 115 may be configured to communicate via frequency bands, such as FR1 having a frequency of 410 to 7125 MHz, FR2 having a frequency of 24250 to 52600 MHz for mm-Wave, and/or one or more other frequency bands. It is noted that sub-carrier spacing (SCS) may be equal to 15, 30, 60, or 120 kHz for some data channels. Second device 405 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via second device 405 and UE 115. For example, the control information may be communicated using MAC-CE transmissions, RRC transmissions, DCI, transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, antenna manager 415, sidelink channel manager 416 and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store second transmission indication data 406, individual transmit power data 408, TTP QCL data 442, settings data 444, or a combination thereof, as further described herein.

The second transmission indication data 406 includes or corresponds to data associated with or corresponding to information which identifies one or more second transmissions (e.g., 454 and/or 456) which are indicated by a first transmission 452. In some implementations, at least one second transmission is related to the first transmission. For example, the second transmission indication data 406 may indicate one or more retransmissions of a first transmission. As another example, at least one transmission of the one or more second transmissions may be different from the first transmission, such as have a different data packet.

The individual transmit power data 408 includes or corresponds to data indicating or corresponding to a transmit power of a particular antenna, such as a particular antenna port or TRP. For example, the individual transmit power data 408 may include or correspond to a transmit power used to transmit the first transmission. Additionally, the individual transmit power data 408 includes one or more transmit powers planned for the one or more second transmissions. To illustrate, for a first antenna port (e.g., TRP 1) the UE 115 plans to use an individual transmit power (ITP) of x dB for a second transmission and ITP of y dB for a third transmission; and for a second antenna port (e.g., TRP 2) the UE 115 plans to use an ITP of y dB for the second transmission and an ITP of x dB for the third transmission.

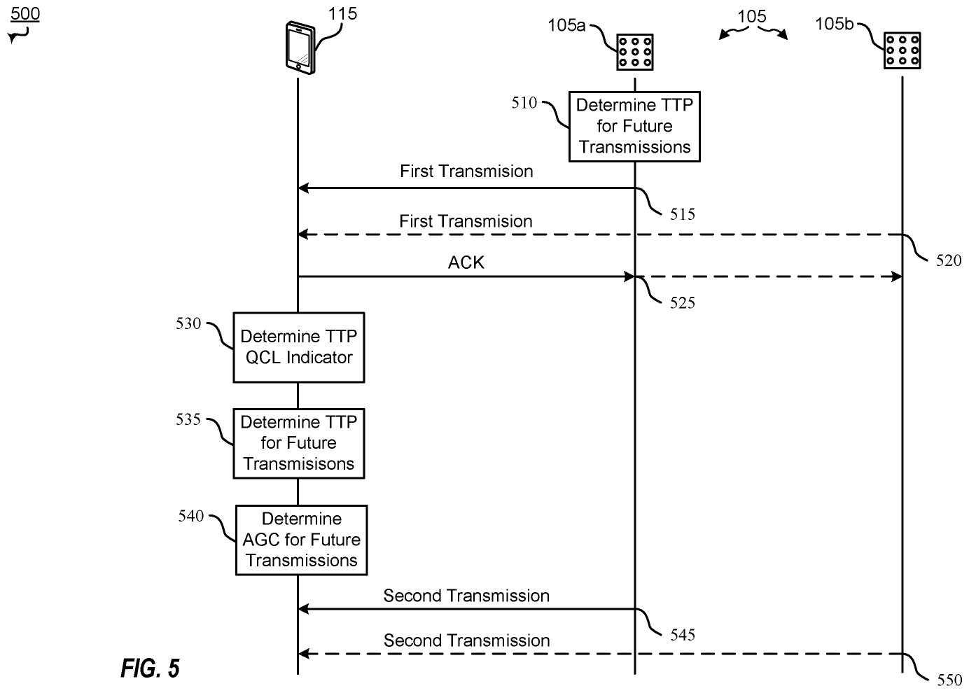

The TTP QCL data 442 includes or corresponds to data indicating or corresponding to a QCL indication which identifies a total transmit power for one or more future transmissions. The TTP QCL data 442 may also include data indicating or corresponding to a QCL indication which identifies a total transmit power for the current or previous transmission, such as the first transmissions 452 which indicates the planned future transmissions. The TTP QCL data 442 may indicate a particular QCL indication mode or type, such as relative indication, absolute indication, single bit indication, bitmap indication, index indication, etc., or a combination thereof. Exemplary QCL indication types are described further with reference to FIG. 5. In another aspect, a transmit power configuration data may be sent in place of the TTP QCL data 442. The transmit power configuration data may be an indication of the TTP. Additionally, the transmit power configuration is a generalization and extension of the TTP QCL indication. Transmit power configuration data may be used to indicate the QCL with respect to one or more of a total transmit power, a transmit power distribution over the transmission antennas, an antenna/TRP selection, a transmit precoder, etc. Alternatively, the transmit power configuration data may indicate one or more of a total transmit power, a transmit power distribution over the transmission antennas, an antenna/TRP selection, a transmit precoder, etc., independent of QCL information. The transmit power configuration may include any transmission related change that the transmitting UE implements that can affect the received power at the receiving UE.

The settings data 444 includes or corresponds to data associated with TTP QCL indication. The settings data 444 may include one or more type of TTP QCL indication modes and/or thresholds or conditions for selecting and/or implementing the TTP QCL indication modes. Additionally, the settings data 444 may include AGC related data. To illustrate, the settings data 444 may include data for predicting or calculating an AGC value based on a TTP QCL indication and the predicted or calculated AGC value.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Antenna manager 415 may be configured to determine and perform antenna mode management and transmit power selection operations. For example, antenna manager 415 is configured to determine transmit power of individual antenna ports for multiple TRP mode and/or sidelink channel mode operation. To illustrate, antenna manager 415 may determine to use a first transmit power for a first antenna and a second transmit power for a second antenna based on a particular operating mode and based on receiver characteristics (e.g., type and/or location). Specifically, the antenna manager 415 may determine to alternate or sweep the transmit power when the data is relevant for all, or the antenna manager 415 may determine to focus the transmit power in a particular location for a particular receiving device based on location. As an example, car to car communication for brake indication may be transmitted with a higher power from a rear facing antenna and communications to a traffic signal may be transmitting with a higher power from a front facing antenna in accordance with their usual location.

SL channel manager 416 may be configured to determine to a sidelink channel operating mode. For example, SL channel manager 416 is configured to determine and/or select a particular SL channel operation mode. To illustrate, SL channel manager 416 is configured to determine a V2V or a V2X operating mode. The SL channel manager 416 may also be configured to apply the determined interleaving mode (e.g., interleave symbols).

Second device 405 includes processor 430, memory 432, transmitter 434, receiver 436, encoder 437, decoder 438, SL channel manager 439, AGC calculator 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store second transmission indication data 406, individual transmit power data 408, total transmit power (TTP) QCL data 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, second device 405 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of second device 405 described with reference to FIG. 2.

Encoder 437, and decoder 438 may include the same functionality as described with reference to encoder 413 and decoder 414, respectively. SL channel manager 439 may include similar functionality as described with reference to SL channel manager 416. AGC calculator 440 may be configured to determine to an AGC value to be used for one or more of the second transmissions. For example, the AGC calculator 440 is configured to predict a AGC to use a start of a slot based on a TTP QCL indication received in a control message. To illustrate, the AGC calculator 440 uses the TTP of the UE 115, and any other UE, to determine a particular AGC value and sets the AGC value for the slot. The AGC calculator 440 may further be configured to adjust the AGC during the slot.

During operation of wireless communications system 400, second device 405 may determine that UE 115 has TTP QCL indication capability. For example, UE 115 may transmit a message 448 that includes a TTP QCL indication capability indicator 490. Indicator 490 may indicate TTP QCL indication capability or a particular type or mode of TTP QCL indication. In some implementations, second device 405 sends control information to indicate to UE 115 that TTP QCL indication and/or a particular type of TTP QCL indication is to be used. For example, in some implementations, message 448 (or another message, such as configuration transmission 450) is transmitted by the second device 405. The configuration transmission 450 may include or indicate to use TTP QCL indication or to adjust or implement a setting of a particular type of TTP QCL indication.

During operation, devices of wireless communications system 400, perform TTP QCL indication and AGC for multiple TRP and/or sidelink channel communication operations. For example, a UE 115 may transmit a first transmission 452 to another wireless communication device, such as second device 105 or third device 401. The first transmission 452 may be a sidelink channel transmission. The sidelink channel transmission may include a data portion and a control portion. The data portion may include or correspond to PSSCH transmission. The control portion may include or correspond to a PSCCH transmission. The control portion may further or alternatively correspond to a sidelink channel information (SCI) transmission, such as a SCI1 or SCI2 transmission.

The control portion indicates one or more future or planned second transmissions. Theses second transmission may include re-transmissions of the first transmission or different transmissions. The second transmissions may be indicated by slot or set of time-frequency resources.

The control portion further indicates a TTP QCL indication for the second transmissions. To illustrate, a QCL indicator of the control portion indicates or identifies the individual transmit power of each TRP of the UE 115 to be used for the upcoming second transmissions, and thus indicates the TTP for the upcoming second transmissions. The total transmit power QCL indicator may include a single bit indication, a bitmap, an index, etc., as described further herein.

After receiving the first transmission 452, the second device 405 may determine an AGC value for one or more of the second transmissions. For example, the second device 405 may determine AGC value data based on the total transmit power QCL indication To illustrate, the second device 405 may determine the AGC value based on the transmit power of the first transmission, the indicated transmit power for the second transmission, a transmit power of other devices, and a Reference Signal Received Power (RSRP) of the UE 115 and/or other devices.

The UE 115 the transmits the second transmission 454 to the second device 405 using the TTP indicated by the TTP QCL indication in the first transmission 452. The second device 405 sets the receive gain value based on the AGC value (e.g., first AGC) at the start of the second transmission 454. Optionally, the second device 405 may adjust the receive gain value based on transient factors or changes to the proposed transmit power of the UE 115 or other transmitting devices.

After receiving the second transmission 454, the second device 405 may determine an AGC value for an optional third transmission 456. For example, the second device 405 may determine a second AGC value data based on the total transmit power QCL indication To illustrate, the second device 405 may determine the second AGC value based on the transmit power of the first transmission 452, the transmit power of the second transmission 454, the indicated transmit power for the third transmission 456, a transmit power of other devices (e.g., third device 401), and an RSRP of the UE 115 and/or other devices.

The UE 115 the transmits the third transmission 456 to the second device 405 using the TTP indicated by the TTP QCL indication in the first transmission 452. The second device 405 sets the second receive gain value based on the second AGC value (e.g., second AGC) at the start of the third transmission 456. Optionally, the second device 405 may adjust the second receive gain value based on transient factors or changes to the proposed transmit power of the UE 115 or other transmitting devices (e.g., third device 401). Thus, the UE 115 and network entities may be able to employ AGC operations when using multiple TRPs and/or performing sidelink channel operations.

Accordingly, FIG. 4 describes enhanced QCL indication for AGC determination for multiple TRPs operations. Using TTP QCL indication may enable AGC determination for multiple TRPs operations and/or increase an accuracy of AGC predictions. Performing QCL indication for AGC determination for multiple TRPs operations enables reduced overhead and power consumption (via reduced or eliminated LNA operations during a slot) and thus, enhanced UE and network performance.

In some implementations, the total transmit power QCL indication includes a single indication (e.g. single bit) which identifies whether or not an individual transmit power of each TRP of the wireless communication device for the second set of one or more of time-frequency resources will be the same as the individual transmit power of each TRP used for the first set of time-frequency resources. By indicating the individual transmit powers of each TRP, the receiving device can determine the TTP.

In some other implementations, the total transmit power QCL indication is a bitmap. In some such implementations, the bitmap indicates whether or not the same individual transmit power allocation of each TRP is being used for the second set of one or more of time-frequency resources (e.g., whether or not the same TRP power allocation is being used). For example, the bitmap includes a single value for each set of time-frequency resources of the second set of one or more of time-frequency resources (e.g., transmission), and a value of 1 indicates the same TRP power allocation and a value of 0 indicates otherwise.

In other such implementations, the bitmap includes multiple values for each set of time-frequency resources of the second set of one or more of time-frequency resources (e.g., multiple values for each transmission to indicate per port QCL indication). For example, each value of the bitmap indicates a power relationship from the power used for the first set of time-frequency resources. To illustrate, a first value indicates double the TRP power allocation used for the first set of time-frequency resources, a second value indicates the same TRP power allocation used for the first set of time-frequency resources, a third value indicates half the TRP power allocation used for the first set of time-frequency resources, and a fourth value indicates no power.

In some additional implementations, the total transmit power QCL indication is an index, and the index indicates whether or not the same individual transmit power allocation of each TRP is being used for the second set of one or more of time-frequency resources. For example, the index is a TCI state index, and a value of 1 indicates the same TRP power allocation and a value of 0 indicates otherwise.

Alternatively, the total transmit power QCL indication provides explicit indications for a portion of the second transmissions and implicit indications for a second portion of the second transmissions. For example, the total transmit power QCL indication is a bitmap of indications for a portion of time-frequency resources of the future resources being reserved in the second set, the bitmap indicates a repeating pattern of information, and the repeating pattern of information provides indications for a remaining portion of resources of the future resources being reserved in the second set.

FIG. 5 illustrates an example ladder diagram for TTP QCL indication operations. Referring to FIG. 5, FIG. 5 is a ladder diagram 500 of an example of TTP QCL indication for AGC for multiple TRPs. The ladder diagram 500 illustrates two devices of a network, a first device (e.g., UE 115) and a second multiple TRP device (e.g., second device 105). The multiple TRP device has a first TRP 105a and a second TRP 105b.

At 510, the second device 105 determines a total transmit power (TTP) for one or more future transmissions. To illustrate, the second device 105 determines one or more second transmissions resources and individual transmit powers for each TRP, i.e., the first TRP 105a and the second TRP 105b. The second device 105 may generate an indicator, i.e., a TTP QCL indicator for the second transmissions resources and include the indication in a first transmission.

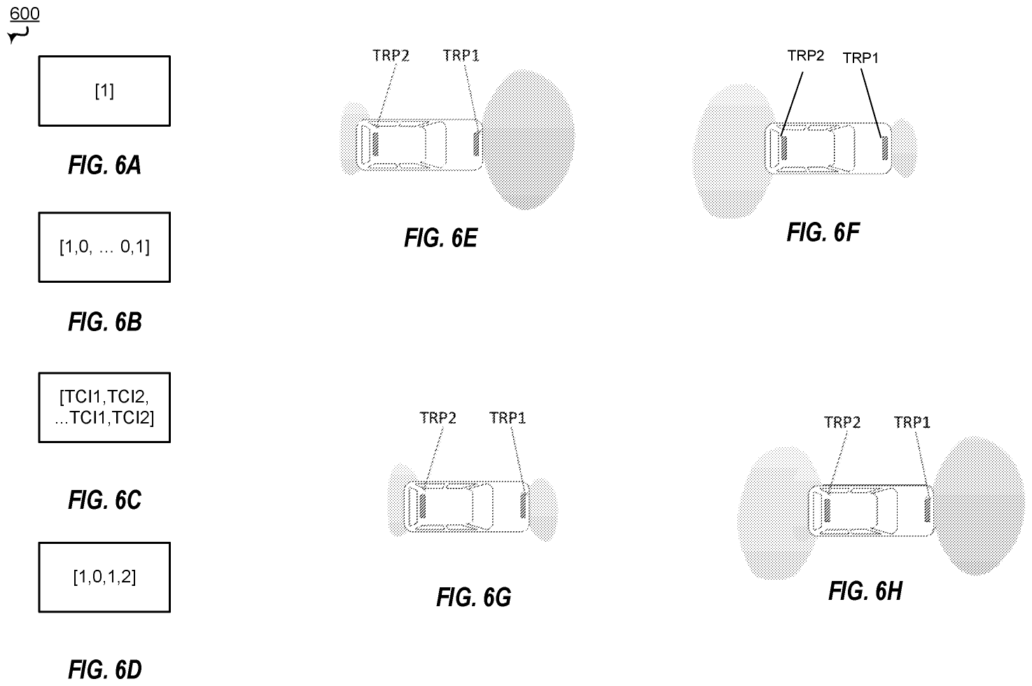

At 515, a first TRP 105a generates and transmits a first transmission. For example, the first TRP 105a sends a PSCCH transmission, a PSSCH transmission, or both. The first transmission indicates the future second transmissions resources and the TTP QCL indication for such resources. For example, a control portion of the first transmission indicates both the future resources and the TTP QCL indication. The particular TTP QCL indication type may be determined based on a setting or operating mode of the network and/or second device 105. Exemplary TTP QCL indications are illustrated and described further with reference to FIG. 6.

At 520, a second TRP 105b, generates and transmits the first transmission. For example, the second TRP 105b sends a PSCCH transmission, a PSSCH transmission, or both. The first transmission from the second TRP 105b may also indicate the future second transmissions resources and the TTP QCL indication for such resources. As illustrated in the example of FIG. 5, the UE 115 may or may not receive such a transmission from the second TRP 105b. To illustrate, the second TRP 105b may be transmitting with a particular beam (e.g., direction) and power such that the UE 115 is not able to receive or decode the transmission. Also, although the first transmissions of 515 and 520 are shown at different times, the first transmissions may be partially overlap each other in time or be simultaneous. The first transmissions of 515 and 520 may be the same transmission, i.e., have a same data packet or data portion.

At 525, a UE 115, optionally, generates and transmits an acknowledgment transmission (ACK). For example, the UE 115 sends a PUCCH transmission/UCI transmission indicating successful reception of at least one of the first transmissions and optionally a confirmation indicator for the TTP QCL indication and/or reserved second resources.

At 530, the UE 115 determines the TTP QCL indication. For example, the UE 115 extracts the TTP QCL indication from a control portion of the first transmission.

At 535, the UE 115 determines a TTP for the future second transmissions. For example, the UE 115 may determine an individual transmit power for the first TRP 105a and an individual transmit power for the second TRP 105b based on the total transmit power QCL indication. In some implementations, the UE 115 may determine the that TTP QCL indication indicates different individual transmit powers for the TRPs for different future transmissions of the second transmissions. For further details regarding the indications and the decoding of the indications, see FIG. 6.

At 530, the UE 115 determines an AGC value based on the TTP QCL indication. For example, the UE 115 determines a TTP for the second device based on the individual transmits powers of the TRPs indicated by the TTP QCL indicator, and then determines an initial gain setting for a particular second transmission based on TTP for the second device. To illustrate, the UE 115 may calculate the AGC based on a receiver gain value for the first transmission, a total received power for the first transmission, a RSRP level for the second device 105, a spatial configuration (e.g., beam configuration) used for the first transmission, the second transmission, or both, or a combination thereof. Additionally, the UE 115 may take into account transmit powers from other devices (not shown). Such transmit powers may also include TTP for multiple TRP devices. For example, the UE 115 may further adjust the gain for other devices, similar to FIG. 3B. Thus, for a third device which has multiple TRPs and is transmitting in the same slot/transmission resources as the second device, the UE 115 may further determine the AGC based on a receiver gain value for a transmission by the third device, a total received power for the transmission by the third device, a RSRP level for the third device, a spatial configuration (e.g., beam configuration) used for the transmission(s) by the third device, or a combination thereof

After determination of the AGC value, the UE 115 sets the receiver gain for a particular upcoming second transmission based on the AGC value. The UE 115 may monitor for incoming transmissions based on the receiver gain value. As the receiver gain value takes into account the TTP of each multiple TRP transmitting device (e.g., by accounting for individual transmit powers of each TRP), the receiver gain value may be more accurate. Thus, the UE 115 may utilize less LNA gain or may not perform LNA based gain adjustment during the second transmission.

At 545, the first TRP 105a generates and transmits a second transmission. For example, the first TRP 105a sends a second PSCCH transmission, a second PSSCH transmission, or both. The second transmission is generated and sent according to the transmit power indication of the first transmission for the first TRP 105a.

At 550, the second TRP 105b generates and transmits a second transmission. For example, the second TRP 105b sends a second PSCCH transmission, a second PSSCH transmission, or both. The second transmission is generated and sent according to the transmit power indication of the first transmission for the second TRP 105b.

The UE 115 receives one or both of the second transmissions from the TRPs. The UE 115 processes the second transmissions based on the receiver gain value set based on multiple TRP AGC via QCL indication. Based on the UE 115 determining that the second transmissions are intended for/indicate the UE 115, the UE 115 may decode and further process the second transmissions. Alternatively, the UE 115 may determine to ignore the second transmissions and not further process and decode such second transmissions based on the UE 115 determining that the second transmissions are not intended for/do not indicate the UE 115. Additionally, the third device may also monitor the transmission resources used for the second transmissions for transmissions intended for the third device. The third device may also determine to ignore the second transmissions and not further process and decode such second transmissions based on the third device determining that the second transmissions are not intended for/do not indicate the third device.

Thus, in the example in FIG. 5, the devices employ TTP QCL indication for AGC in multiple TRP operations. That is, the devices can account for the individual transmit powers of each TRP when determining AGC/performing AGC operations.

FIGS. 6A-6H illustrate examples of TTP QCL indication schemes. FIGS. 6A-6D illustrate various types of QCL indicators, and FIGS. 6E-6H illustrate examples of different resulting TRP transmit signal powers. Referring to FIG. 6A, FIG. 6A illustrates an example of single bit type of TTP QCL indicator. The single bit indicator may indicate whether or not the transmitting device intends to reuse the individual and total transmit powers used for the antenna ports/TRPs during the first transmission for one or more future transmissions. As an illustrative, example, a value of 1 may indicate the same TTP and ITP and a value of 0 may indicate otherwise, such as no indication or a default indication.

Referring to FIG. 6B, FIG. 6B illustrates an example of a bitmap type of TTP QCL indicator. The bitmap indicator may provide an indication for each transmission of the future transmissions. In some implementations, the bitmap indicator is per device. For example, similar to the single bit indicator of FIG. 6A, each bit of the bitmap indicates whether or not the transmitting device intends to reuse the individual and total transmit powers used for the antenna ports/TRPs during the first transmission for a particular future transmission of the one or more future transmissions. As an illustrative, example, a value of 1 may indicate the same TTP and ITP and a value of 0 may indicate otherwise, such as no indication or a default indication.

In some other implementations, the bitmap is per antenna port/TRP. In such implementations, the bitmap may include multiple bits per transmission. To illustrate, for a two TRP device, the bitmap has two indicators per transmission, one for each TRP.

Although the indications described in FIGS. 6A and 6B are one bit indications (e.g., 0 or 1), in other implementations, each indication may itself be multiple bits. For example, a two bit indicator or four option indication can be used. To illustrate, a first value (2 or 11) indicates double the TRP power allocation used for the first transmission, a second value (1 or 10) indicates the same TRP power allocation used for the first transmission, a third value (0.5 or 01) indicates half the TRP power allocation used for the first transmission, and a fourth value (0 or 00) indicates no power.

Referring to FIG. 6C, FIG. 6C illustrates an example of an index type of TTP QCL indicator. In the example of FIG. 6C, the index used is a TCI state index. In other examples, other indices/fields of the control portion of the first transmission may be used. The index indicator may provide an indication for each transmission of the future transmissions.

In some implementations, the index indicator is per device. For example, each indication of the bitmap indicates a TCI state for the device as a whole for a particular transmission. To illustrate, a TCI state of 2 may indicate that the receiving device may reuse the individual and total transmit powers used for the antenna ports/TRPs during the first transmission for a particular future transmission of the one or more future transmissions, and a TCI state of 1 may indicate that the receiving device may not reuse the transmit powers. In other implementations, such as for different indices (e.g., non-TCI state indices) the index indicator may be per antenna port/TRP.

Referring to FIG. 6D, FIG. 6D illustrates an example of a partial bitmap type of TTP QCL indicator. The partial bitmap indicator may provide an explicit indication for some transmissions of the future transmissions and an implicit indication for other transmissions of the future transmissions. To illustrate, the future reserved resources may indicate the next 10 transmissions. However, the bitmap may only include indications for a portion of the transmissions, such as two or five of the transmissions. The indications of the bitmap may be interpreted by a receiving device as repeating for the rest of the transmissions reserved. Similar to the bitmap indications of FIGS. 6A and 6B, the individual indications of the partial bitmap may be single bit indicators, multiple bit indicators, per device indicators, per antenna port/TRP indicators, or any combination thereof Alternatively, in other implementations the TTP QCL indicator may be a partial or repeating index, such as described with reference to FIG. 6C.

Referring to FIGS. 6E-6H, illustrations of example transmit power configurations are shown. FIGS. 6E-6H illustrate a vehicle with two TRPs, a first TRP (TRP1) on a front of the vehicle and a second TRP (TRP2) on a back of the vehicle. FIG. 6E illustrates the first TRP (TRP1) at a first transmit power and the second TRP (TRP2) at a second transmit power. FIG. 6F illustrates the first TRP (TRP1) at the second transmit power and the second TRP (TRP2) at the first transmit power. FIG. 6G illustrates both TRPs (TRP1 and TRP2) at the second transmit power. FIG. 6H illustrates both TRPs (TRP1 and TRP2) at the first transmit power.

Although FIGS. 4-6H are directed to an example of TTP QCL indications, in another aspect, a transmit power configuration indication may be sent in place of the TTP QCL indication in other implementations. Additionally, the example configurations and indications of the TTP QCL indicator may be used to indicate a transmit power configuration indicator or indication.

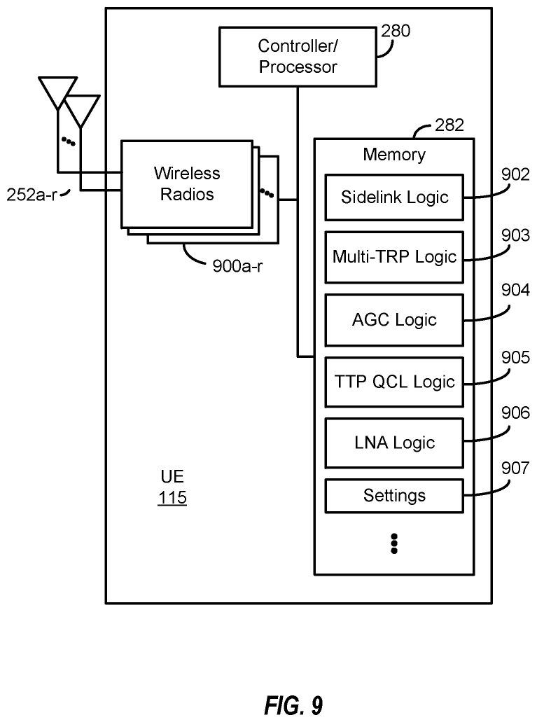

FIG. 7 is a flow diagram illustrating example blocks executed by a UE configured according to an aspect of the present disclosure. The example blocks will also be described with respect to UE 115 as illustrated in FIG. 9. FIG. 9 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 900a-r and antennas 252a-r. Wireless radios 900a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 9, memory 282 stores sidelink channel logic 902, multiple TRP logic 903, AGC logic 904, TTP QCL logic 905, LNA logic 906, and settings data 907.

At block 700, a wireless communication device, such as a UE, transmits a transmission using a first set of transmission resources. The transmission includes an indication of a second set of one or more of transmission resources in the future that the wireless communication device intends to use for one or more second transmissions, and transmission includes a total transmit power QCL indication for at least one transmission of the one or more second transmissions. For example, the UE 115 transmits a transmission including a control portion which indicates future reserved transmission resources (e.g., sets of time-frequency resources) and power indications for the future reserved transmission resources, as described with reference to FIGS. 4, 5, and 6A-H. To illustrate, the control portion may include a TTP QCL indicator, such as described with reference to FIGS. 6A-6D, which indicates a TTP for the future reserved transmission resources. The TTP may be indicated by indicating an ITP for each antenna port/TRP of the UE.

At block 701, the UE 115 transmits a particular transmission of the one or more second transmissions using a particular set of transmission resources of the second set of one or more of transmission resources based on the total transmit power QCL indication. For example, the UE 115 generates and sends a second transmission according to the TTP QCL indication of the first transmission, as described with reference to FIGS. 4 and 5. To illustrate, the UE 115 may generate and send a PSCCH transmission, a PSSCH transmission, or both, and the PSSCH if included, may be the same as or different from a PSSCH of the first transmission. In addition, based on the TTP QCL indication, the first and second transmissions may have the same or different TTP settings and/or ITP settings.

In another aspect, a transmit power configuration indication may be sent in place of the total transmit power QCL indication. The transmit power configuration indication may be an indication of a TTP. Additionally, the transmit power configuration is a generalization and extension of the TTP QCL indication. Transmit power configuration QCL indication may be used to indicate the QCL with respect to one or more of a total transmit power, a transmit power distribution over the transmission antennas, an antenna/TRP selection, a transmit precoder, etc. Alternatively, the transmit power configuration data may indicate one or more of a total transmit power, a transmit power distribution over the transmission antennas, an antenna/TRP selection, a transmit precoder, etc., independent of QCL information. The transmit power configuration may include any transmission related change that the transmitting UE implements that can affect the received power at the receiving UE.

The UE 115 may execute additional blocks (or the UE 115 may be configured further to perform additional operations) in other implementations. For example, the UE 115 may perform one or more operations described above. As another example, the wireless communication device may perform one or more of the below aspects.

In a first aspect, the wireless communication device is a multiple TRP UE and has multiple TRPs.

In a second aspect, alone or in combination with one or more of the above aspects, the total transmit power QCL indication includes transmit power information for each TRP of multiple TRPs.

In a third aspect, alone or in combination with one or more of the above aspects, the wireless communication device is operating in a V2X mode, and the total transmit power QCL indication enables a receiving device to perform automatic gain control (AGC) prediction.

In a fourth aspect, alone or in combination with one or more of the above aspects, the total transmit power QCL indication is included in a control message of the first transmission.

In a fifth aspect, alone or in combination with one or more of the above aspects, the control message is a PSCCH transmission.

In a sixth aspect, alone or in combination with one or more of the above aspects, the control message is a SCI1 transmission.

In a seventh aspect, alone or in combination with one or more of the above aspects, the control message is a SCI2 transmission.

In an eighth aspect, alone or in combination with one or more of the above aspects, the first transmission further includes a data portion.

In a ninth aspect, alone or in combination with one or more of the above aspects, the data portion is a PSSCH transmission.

In a tenth aspect, alone or in combination with one or more of the above aspects, at least one transmission of the one or more second transmissions includes the same data packet as the first transmission.

In an eleventh aspect, alone or in combination with one or more of the above aspects, at least one transmission of the one or more second transmissions includes a different data packet from the first transmission.

In a twelfth aspect, alone or in combination with one or more of the above aspects, the total transmit power QCL indicator provides a QCL indication indicating total transmit power for each set of transmission resources of the second set of one or more of transmission resources.

In a thirteenth aspect, alone or in combination with one or more of the above aspects, the total transmit power QCL indication includes a single indication which identifies whether or not an individual transmit power of each TRP of the wireless communication device for the second set of one or more of transmission resources will be the same as the individual transmit power of each TRP used for the first set of transmission resources.

In a fourteenth aspect, alone or in combination with one or more of the above aspects, the total transmit power QCL indication is a bitmap, and the bitmap indicates whether or not the same individual transmit power allocation of each TRP is being used for the second set of one or more of transmission resources (e.g., whether or not the same TRP power allocation is being used).

In a fifteenth aspect, alone or in combination with one or more of the above aspects, the bitmap includes a single value for each set of transmission resources of the second set of one or more of transmission resources (e.g., transmission), and a value of 1 indicates the same TRP power allocation and a value of 0 indicates otherwise.

In a sixteenth aspect, alone or in combination with one or more of the above aspects, the bitmap includes multiple values for each set of transmission resources of the second set of one or more of transmission resources (e.g., multiple values for each transmission to indicate per port QCL indication), and a value of the bitmap indicates a power relationship from the power used for the first set of transmission resources.

In a seventeenth aspect, alone or in combination with one or more of the above aspects, a first value indicates double the TRP power allocation used for the first set of transmission resources, a second value indicates the same TRP power allocation used for the first set of transmission resources, a third value indicates half the TRP power allocation used for the first set of transmission resources, and a fourth value indicates no power.

In an eighteenth second aspect, alone or in combination with one or more of the above aspects, the total transmit power QCL indication is an index, and the index indicates whether or not the same individual transmit power allocation of each TRP is being used for the second set of one or more of transmission resources.

In a nineteenth aspect, alone or in combination with one or more of the above aspects, the index is a TCI state index, and a value of 1 indicates the same TRP power allocation and a value of 0 indicates otherwise.

In a twentieth aspect, alone or in combination with one or more of the above aspects, the total transmit power QCL indication is a bitmap of indications for a portion of transmission resources of the future resources being reserved in the second set, the bitmap indicates a repeating pattern of information, and the repeating pattern of information provides indications for a remaining portion of resources of the future resources being reserved in the second set.

In a twenty-first aspect, alone or in combination with one or more of the above aspects, the transmission resources correspond to time-frequency resources, and the total transmit power QCL indication indicates transmit power information for each TRP of the UE.

In a twenty-second aspect, alone or in combination with one or more of the above aspects, the wireless communication device, prior to transmitting, transmits a capabilities message indicating that the wireless communication device is configured for QCL based total transmit power indication.

In a twenty-third aspect, alone or in combination with one or more of the above aspects, the wireless communication device, prior to transmitting, receives a capabilities message indicating that a second wireless communication device is configured for QCL based total transmit power indication.

In a twenty-fourth aspect, alone or in combination with one or more of the above aspects, the wireless communication device, prior to transmitting, receives a configuration message from a second wireless communication device indicating a QCL based total transmit power indication mode.

In another aspect, a method of wireless communication includes: transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a transmit power configuration indication for at least one transmission of the one or more second transmissions; and transmitting, by the wireless communication device, a particular transmission of the one or more second transmissions using a particular set of transmission resources of the second set of one or more of transmission resources based on the transmit power configuration indication.

In an additional aspect, the method further includes any of the second through the twenty-fourth aspects.

In an additional aspect, the transmit power configuration indication is a relative, differential, or ratio type indication.

In an additional aspect, the transmit power configuration includes a total transmit power indication, a power distribution indication, a transmit antenna configuration, a precoder configuration or a combination thereof.

In an additional aspect, the transmit power configuration includes a total transmit power indication, a power distribution indication, a transmit antenna configuration, a precoder configuration or a combination thereof.

In an additional aspect, the transmit power configuration is used to indicate a QCL indicator or information with respect to one or more of a total transmit power, a transmit power distribution over the transmission antennas, an antenna selection, a TRP selection, or a transmit precoder.

In an additional aspect, the transmit power configuration indicates any transmission change that the transmitting UE does that can significantly affect the received power at the receiver UE.

Accordingly, a UE and a base station may perform QCL indication for AGC determination for multiple TRPs operations. By performing QCL indication for AGC determination for multiple TRP operations, throughput and reliability may be increased.

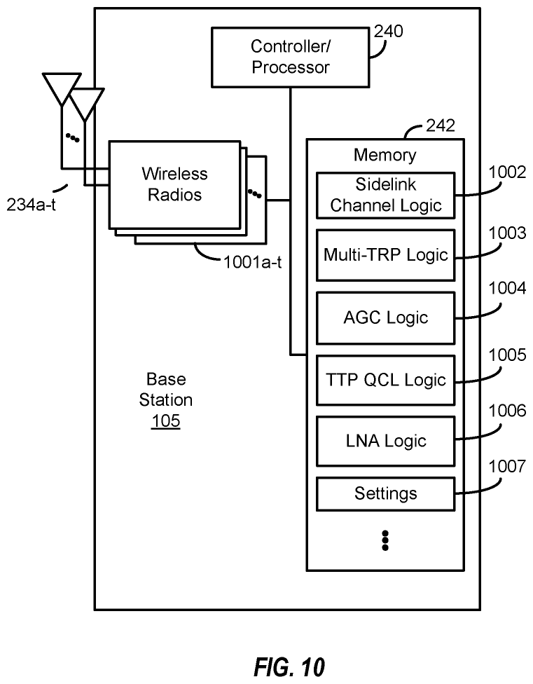

FIG. 8 is a flow diagram illustrating example blocks executed by wireless communication device configured according to another aspect of the present disclosure. The wireless communication device is a receiving device and may be a UE or a base station. The example blocks will also be described with respect to a base station 105 (e.g., gNB) as illustrated in FIG. 10. FIG. 10 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1001a-t and antennas 234a-t. Wireless radios 1001a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 10, memory 242 stores sidelink channel logic 1002, multiple TRP logic 1003, AGC logic 1004, TTP QCL logic 1005, LNA logic 1006, and settings data 1007. One of more of 1002-1007 may include or correspond to one of 902-907.

At block 800, a wireless communication device, such as a UE or base station, receives, from a second wireless communication device, a transmission for a first set of transmission resources. The transmission includes an indication of a second set of one or more of transmission resources in the future that the second wireless communication device intends to use for one or more second transmissions, and the transmission includes a total transmit power QCL indication for at least one transmission resource set of the second set of one or more of transmission resources. For example, the UE 115 or base station 105 receives a transmission including a control portion which indicates future reserved transmission resources (e.g., sets of time-frequency resources) and power indications for the future reserved transmission resources, as described with reference to FIGS. 4, 5, and 6A-H. To illustrate, the control portion may include a TTP QCL indicator, such as described with reference to FIGS. 6A-6D, which indicates a TTP for the future reserved transmission resources. The TTP may be indicated by indicating an ITP for each antenna port/TRP of the UE.

At block 801, the UE 115 or base station 105 determines a total transmit power for a particular set of transmission resources of the second set of one or more of transmission resources based on the total transmit power QCL indication. For example, the UE 115 or base station 105 determines a particular type of TTP QCL indicator, such as based on a TTP QCL indication mode, and determines ITP for each antenna port based on the TTP QCL indicator, as described with reference to FIGS. 4, 5, and 6A-6H.

At block 802, the UE 115 or base station 105 determines a receiver gain value to apply for receptions during the particular set of transmission resources based on the total transmit power for a particular set of transmission resources. For example, the UE 115 or base station 105 calculates a predicted receiving gain to use based on the TTP and ITP for an upcoming reserved set of transmission resources, as described with reference to FIGS. 3A, 4, and 5.

At block 803, the UE 115 or base station 105 monitors for a particular transmission of the one or more second transmissions during the particular set of transmission resources using the receive gain value. For example, the UE 115 or base station 105 receives a second transmission according to the TTP QCL indication of the first transmission, as described with reference to FIGS. 4 and 5. To illustrate, the UE 115 or base station 105 receives a PSCCH transmission, a PSSCH transmission, or both, and the PSSCH if included, may be the same as or different from a PSSCH of the first transmission. In addition, based on the TTP QCL indication, the first and second transmissions may have the same or different TTP settings and/or ITP settings.

In another aspect, a transmit power configuration indication may be sent in place of the total transmit power QCL indication. The transmit power configuration indication may be an indication of a TTP. Additionally, the transmit power configuration is a generalization and extension of the TTP QCL indication. Transmit power configuration QCL indication may be used to indicate the QCL with respect to one or more of a total transmit power, a transmit power distribution over the transmission antennas, an antenna/TRP selection, a transmit precoder, etc. Alternatively, the transmit power configuration data may indicate one or more of a total transmit power, a transmit power distribution over the transmission antennas, an antenna/TRP selection, a transmit precoder, etc., independent of QCL information. The transmit power configuration may include any transmission related change that the transmitting UE implements that can affect the received power at the receiving UE.

The UE 115 or base station 105 may execute additional blocks (or the UE 115 or base station 105 may be configured further to perform additional operations) in other implementations. For example, the base station 105 may perform one or more operations described above. As another example, the wireless communication device (UE 115 or base station 105) may perform one or more of the below aspects.

In a first aspect, the wireless communication device is a multiple TRP UE and has multiple TRPs.

In a second aspect, alone or in combination with one or more of the above aspects, the total transmit power QCL indication includes transmit power information for each TRP of multiple TRPs.

In a third aspect, alone or in combination with one or more of the above aspects, the wireless communication device is operating in a V2X mode, and the total transmit power QCL indication enables a receiving device to perform automatic gain control (AGC) prediction.

In a fourth aspect, alone or in combination with one or more of the above aspects, the total transmit power QCL indication is included in a control message of the first transmission.

In a fifth aspect, alone or in combination with one or more of the above aspects, the control message is a PSCCH transmission.

In a sixth aspect, alone or in combination with one or more of the above aspects, the control message is a SCI1 transmission.

In a seventh aspect, alone or in combination with one or more of the above aspects, the control message is a SCI2 transmission.

In an eighth aspect, alone or in combination with one or more of the above aspects, the first transmission further includes a data portion.

In a ninth aspect, alone or in combination with one or more of the above aspects, the data portion is a PSSCH transmission.

In a tenth aspect, alone or in combination with one or more of the above aspects, at least one transmission of the one or more second transmissions includes the same data packet as the first transmission.

In an eleventh aspect, alone or in combination with one or more of the above aspects, at least one transmission of the one or more second transmissions includes a different data packet from the first transmission.

In a twelfth aspect, alone or in combination with one or more of the above aspects, the total transmit power QCL indicator provides a QCL indication indicating total transmit power for each set of transmission resources of the second set of one or more of transmission resources.

In a thirteenth aspect, alone or in combination with one or more of the above aspects, the total transmit power QCL indication includes a single indication which identifies whether or not an individual transmit power of each TRP of the second wireless communication device for the second set of one or more of transmission resources will be the same as the individual transmit power of each TRP used for the first set of transmission resources.

In a fourteenth aspect, alone or in combination with one or more of the above aspects, the total transmit power QCL indication is a bitmap, and the bitmap indicates whether or not the same individual transmit power allocation of each TRP is being used for the second set of one or more of transmission resources (e.g., whether or not the same TRP power allocation is being used).

In a fifteenth aspect, alone or in combination with one or more of the above aspects, the bitmap includes a single value for each set of transmission resources of the second set of one or more of transmission resources (e.g., transmission), and a value of 1 indicates the same TRP power allocation and a value of 0 indicates otherwise.

In a sixteenth aspect, alone or in combination with one or more of the above aspects, the bitmap includes multiple values for each set of transmission resources of the second set of one or more of transmission resources (e.g., multiple values for each transmission to indicate per port QCL indication), and a value of the bitmap indicates a power relationship from the power used for the first set of transmission resources.

In a seventeenth aspect, alone or in combination with one or more of the above aspects, a first value indicates double the TRP power allocation used for the first set of transmission resources, a second value indicates the same TRP power allocation used for the first set of transmission resources, a third value indicates half the TRP power allocation used for the first set of transmission resources, and a fourth value indicates no power.

In an eighteenth second aspect, alone or in combination with one or more of the above aspects, the total transmit power QCL indication is an index, and the index indicates whether or not the same individual transmit power allocation of each TRP is being used for the second set of one or more of transmission resources.

In a nineteenth aspect, alone or in combination with one or more of the above aspects, the index is a TCI state index, and a value of 1 indicates the same TRP power allocation and a value of 0 indicates otherwise.

In a twentieth aspect, alone or in combination with one or more of the above aspects, the total transmit power QCL indication is a bitmap of indications for a portion of transmission resources of the future resources being reserved in the second set, the bitmap indicates a repeating pattern of information, and the repeating pattern of information provides indications for a remaining portion of resources of the future resources being reserved in the second set.

In a twenty-first aspect, alone or in combination with one or more of the above aspects, the transmission resources correspond to time-frequency resources, and the total transmit power QCL indication indicates transmit power information for each TRP of the UE.

In a twenty-second aspect, alone or in combination with one or more of the above aspects, the wireless communication device, prior to receiving, transmits a capabilities message indicating that the wireless communication device is configured for QCL based total transmit power indication.

In a twenty-third aspect, alone or in combination with one or more of the above aspects, the wireless communication device, prior to receiving, receives a capabilities message indicating that the second wireless communication device is configured for QCL based total transmit power indication.

In a twenty-fourth aspect, alone or in combination with one or more of the above aspects, the wireless communication device, prior to receiving, transmits a configuration message device indicating a QCL based total transmit power indication mode.

In a twenty-fifth aspect, alone or in combination with one or more of the above aspects, the receiver gain value is further determined based on a second receiver gain value for the first set of transmission resources, a total received power for the first set of transmission resources, a RSRP level for the second wireless communication device, a spatial configuration (e.g., beam configuration) used for the first set of transmission resources, the particular set of transmission resources, or both, or a combination thereof.

In a twenty-sixth aspect, alone or in combination with one or more of the above aspects, the wireless communication device receives the particular transmission, determines the particular transmission is intended for the wireless communication device, and processes the particular transmission.

In a twenty-seventh aspect, alone or in combination with one or more of the above aspects, the wireless communication device receives the particular transmission, determines the particular transmission is not intended for the wireless communication device, and ignores the particular transmission.

In another aspect of the disclosure, a method of wireless communication includes receiving, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a transmit power configuration indication for at least one transmission resource set of the second set of one or more of transmission resources; determining, by the wireless communication device, a total transmit power for a particular set of transmission resources of the second set of one or more of transmission resources based on the transmit power configuration indication; determining, by the wireless communication device, a receiver gain value to apply for receptions during the particular set of transmission resources based on the total transmit power for a particular set of transmission resources; and monitoring, by the wireless communication device, for a particular transmission of the one or more second transmissions during the particular set of transmission resources using the receive gain value.

In an additional aspect, the method further includes any of the second through the twenty-seventh aspects.

Accordingly, a UE and a base station may perform QCL indication for AGC determination for multiple TRPs operations. By performing QCL indication for AGC determination for multiple TRP operations, throughput and reliability may be increased.

Although FIG. 7, i.e., the transmitting device, has been described with reference to a UE, and FIG. 8, i.e., the receiving device, has been described with reference to a base station, in other implementations the receiving device may be another UE. Additionally, or alternatively, the transmitting device may be base station. In some implementations, one or more of the transmitting device or the receiving device may be configured to perform the other operations (e.g., receive or transmit respectively).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIG. 2) may comprise processors, electronics devices, hardware devices, electronics components, logical circuits, memories, software codes, firmware codes, etc., or any combination thereof. In addition, features discussed herein relating to QCL indication for AGC may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 7 and 8) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power quasi co-location (QCL) indication for at least one transmission of the one or more second transmissions; and
transmitting, by the wireless communication device, a particular transmission of the one or more second transmissions using a particular set of transmission resources of the second set of one or more of transmission resources based on the total transmit power QCL indication.

2. The method of claim 1, wherein the wireless communication device is a multiple transmission reception point (TRP) user equipment (UE) and has multiple TRPs.

3. The method of claim 2, wherein the total transmit power QCL indication includes transmit power information for each TRP of multiple TRPs.

4. The method of claim 1, wherein the wireless communication device is operating in a vehicle-to-everything (V2X) mode, and wherein the total transmit power QCL indication enables a receiving device to perform automatic gain control (AGC) prediction.

5. The method of claim 1, wherein the total transmit power QCL indication is included in a control message of the transmission.

6. The method of claim 5, wherein the control message is a physical sidelink control channel (PSCCH) transmission.

7. The method of claim 5, wherein the control message is a sidelink control information type 1 (SCI1) transmission.

8. The method of claim 5, wherein the control message is a sidelink control information type 2 (SCI2) transmission.

9. The method of claim 1, wherein the first transmission further includes a data portion.

10. The method of claim 9, wherein the data portion is a physical sidelink shared channel (PSSCH) transmission.

11. The method of claim 1, wherein at least one transmission of the one or more second transmissions includes the same data packet as the first transmission.

12. The method of claim 1, wherein at least one transmission of the one or more second transmissions includes a different data packet from the first transmission.

13. The method of claim 1, wherein the total transmit power QCL indicator provides a QCL indication indicating total transmit power for each set of transmission resources of the second set of one or more of transmission resources.

14. The method of claim 1, wherein the total transmit power QCL indication includes a single indication which identifies whether or not an individual transmit power of each transmission reception point (TRP) of the wireless communication device for the second set of one or more of transmission resources will be the same as the individual transmit power of each TRP used for the first set of transmission resources.

15. The method of claim 1, wherein the total transmit power QCL indication is a bitmap, and wherein the bitmap indicates whether or not the same individual transmit power allocation of each transmission reception point (TRP) is being used for the second set of one or more of transmission resources.

16. The method of claim 15, wherein the bitmap includes a single value for each set of transmission resources of the second set of one or more of transmission resources, and wherein a first value indicates a same TRP power allocation and a second value indicates otherwise.

17. The method of claim 15, wherein the bitmap includes multiple values for each set of transmission resources of the second set of one or more of transmission resources, and wherein a value of the bitmap indicates a power relationship from the power used for the first set of transmission resources.

18. The method of claim 17, wherein:
a first value indicates double the TRP power allocation used for the first set of transmission resources;
a second value indicates the same TRP power allocation used for the first set of transmission resources;
a third value indicates half the TRP power allocation used for the first set of transmission resources; and
a fourth value indicates no power.

19. The method of claim 1, wherein the total transmit power QCL indication is an index, and wherein the index indicates whether or not the same individual transmit power allocation of each transmission reception point (TRP) is being used for the second set of one or more of transmission resources.

20. The method of claim 19, wherein the index is a TCI state index, and wherein a first value indicates the same TRP power allocation and a second value indicates otherwise.

21. The method of claim 1, wherein the total transmit power QCL indication is a bitmap of indications for a portion of transmission resources of the future transmission resources being reserved in the second set, wherein the bitmap indicates a repeating pattern of information, and wherein the repeating pattern of information provides indications for a remaining portion of resources of the future resources being reserved in the second set.

22. The method of claim 1, wherein the transmission resources correspond to time-frequency resources, and wherein the total transmit power QCL indication indicates transmit power information for each transmission reception point (TRP) of the wireless communication device.

23. The method of claim 1, further comprising, prior to transmitting, transmitting, by the wireless communication device, a capabilities message indicating that the wireless communication device is configured for QCL based total transmit power indication.

24. The method of claim 1, further comprising, prior to transmitting, receiving, by the wireless communication device, a capabilities message indicating that a second wireless communication device is configured for QCL based total transmit power indication.

25. The method of claim 1, further comprising, prior to transmitting, receiving, by the wireless communication device, a configuration message from a second wireless communication device indicating a QCL based total transmit power indication mode.

26. A method of wireless communication comprising:
receiving, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a total transmit power quasi co-location (QCL) indication for at least one transmission resource set of the second set of one or more of transmission resources;
determining, by the wireless communication device, a total transmit power for a particular set of transmission resources of the second set of one or more of transmission resources based on the total transmit power QCL indication;
determining, by the wireless communication device, a receiver gain value to apply for receptions during the particular set of transmission resources based on the total transmit power for a particular set of transmission resources; and
monitoring, by the wireless communication device, for a particular transmission of the one or more second transmissions during the particular set of transmission resources using the receive gain value.

27. The method of claim 26, wherein the receiver gain value is further determined based on a second receiver gain value for the first set of transmission resources, a total received power for the first set of transmission resources, a Reference Signal Received Power (RSRP) level for the second wireless communication device, a spatial configuration used for the first set of transmission resources, the particular set of transmission resources, or both, or a combination thereof.

28. The method of claim 26, further comprising:
receiving, by the wireless communication device, the particular transmission;
determining, by the wireless communication device, that the particular transmission is intended for the wireless communication device; and
processing, by the wireless communication device, the particular transmission.

29. The method of claim 26, further comprising:
receiving, by the wireless communication device, the particular transmission;
determining, by the wireless communication device, that the particular transmission is not intended for the wireless communication device; and
ignoring, by the wireless communication device, the particular transmission.

30. The method of claim 26, wherein the wireless communication device is a multiple transmission reception point (TRP) user equipment (UE) and has multiple TRPs, and wherein the total transmit power QCL indication includes transmit power information for each TRP of multiple TRPs.

31. The method of claim 26, wherein the wireless communication device is operating in a vehicle-to-everything (V2X) mode, and wherein the total transmit power QCL indication enables the wireless communication device to perform automatic gain control (AGC) prediction.

32. An apparatus configured for wireless communication, comprising:
at least one processor; and
a memory coupled to the at least one processor,
wherein the at least one processor is configured to:
transmit, by a wireless communication device, a transmission using a first set of transmission resources, wherein the transmission includes an indication of a second set of one or more of transmission resources in the future that the wireless communication device intends to use for one or more second transmissions, and wherein the transmission includes a total transmit power quasi co-location (QCL) indication for at least one transmission of the one or more second transmissions; and
transmit, by the wireless communication device, a particular transmission of the one or more second transmissions using a particular set of transmission resources of the second set of one or more of transmission resources based on the total transmit power QCL indication.

33. An apparatus configured for wireless communication, comprising:
at least one processor; and
a memory coupled to the at least one processor,
wherein the at least one processor is configured to:
receive, by a wireless communication device from a second wireless communication device, a transmission for a first set of transmission resources, wherein the transmission includes an indication of a second set of one or more of transmission resources in the future that the second wireless communication device intends to use for one or more second transmissions, and wherein the transmission includes a total transmit power quasi co-location (QCL) indication for at least one transmission resource set of the second set of one or more of transmission resources;
determine, by the wireless communication device, a total transmit power for a particular set of transmission resources of the second set of one or more of transmission resources based on the total transmit power QCL indication;
determine, by the wireless communication device, a receiver gain value to apply for receptions during the particular set of transmission resources based on the total transmit power for a particular set of transmission resources; and
monitor, by the wireless communication device, for a particular transmission of the one or more second transmissions during the particular set of transmission resources using the receive gain value.

34. A method of wireless communication comprising:
transmitting, by a wireless communication device, a transmission using a first set of transmission resources, wherein the transmission includes an indication of a second set of one or more of transmission resources in the future that the wireless communication device intends to use for one or more second transmissions, and wherein the transmission includes a transmit power configuration indication for at least one transmission of the one or more second transmissions; and
transmitting, by the wireless communication device, a particular transmission of the one or more second transmissions using a particular set of transmission resources of the second set of one or more of transmission resources based on the transmit power configuration indication.

35-45. (canceled)
